(19) United States
(12) Patent Application Publication
(10) Pub. No.: US 2026/0131968 A1
(43) Pub. Date: May 14, 2026

(54) WASTE COLLECTION SYSTEM

(71) Applicant: Bin Diversion Recycling and Salvaging Inc., Sidney (CA)

(72) Inventor: Bradley Todd Munro, Brentwood Bay (CA)

(73) Assignee: Bin Diversion Recycling and Salvaging Inc., Sidney (CA)

(21) Appl. No.: 19/370,060

(22) Filed: Oct. 27, 2025

(30) Foreign Application Priority Data
Nov. 12, 2024 (CA) 3253509

(51) Int. Cl. B65F 1/06; B65F 1/12; B65F 1/14; B65F 1/16

(52) U.S. Cl. CPC B65F 1/06; B65F 1/12; B65F 1/1405; B65F 1/1607; B65F 1/1646; B65F 2001/1653; B65F 2210/181

(57) ABSTRACT

A waste collection system, and a kit for the same is disclosed. The system includes a receptacle, a first bag, and a second bag. A vessel of the receptacle defines an opening that opens into an interior thereof and at least one drainage aperture to allow gas exchange between the interior and an exterior. A valve is mounted on to the vessel to mitigate flow of waste from the interior to the exterior via the opening. A first plurality of retaining elements is distributed around the opening exterior to the valve. A first bag, which is perforated and expandable, is mounted in the interior of the vessel around the opening to receive waste via the valve. The second bag has a fenestrated body with an open end and a second plurality of retaining elements complementary to the first plurality of retaining elements to retain the second bag around the opening.

### TECHNICAL FIELD

The disclosure relates generally to waste management systems, and more particularly to waste collection systems.

### BACKGROUND

Plastic pollution is a serious environmental problem that has taken center stage in recent years. Reducing plastic use and recycling have become the primary means to combat the growing amount of plastic waste inundating the environment and wreaking havoc on sensitive ecosystems and on the health of both humans and animals. A key development in recent years that has helped improve the rate of recycling of plastics has been widespread source separation. For example, household now commonly have multiple waste bins to separate their waste based on the material composition thereof. Source separation reduces the cost to recycle plastics, thereby making it more economically attractive.

A persistent challenge in collection and recycling of plastics is the collection of soft plastics. These types of plastics can be more expensive to process than rigid plastics. The collection of soft plastics is difficult since they tend to take up significantly more air volume than rigid plastics when disposed of and because they cannot simply be thrown in with the rigid plastics, due to differences in the way these two classes of plastics are recycled.

Often households will not generate sufficient soft plastic to warrant a separate collection bin for soft plastics, e.g. the costs associated with providing and managing an extra collection bin may not justify the amount of soft plastics collected. Even when separate bins are provided, they tend to fill up quickly.

Materials such as hard plastics, metal, glass, or paper are processed in Material Recovery Facilities (MRFs). It is important that the input waste streams for these MRFs be clear of contamination in the form co-mingled soft plastic packaging. Removing soft plastic packaging from MRF input waste streams is often difficult and costly. When left unchecked or missed during sorting, soft plastic packaging can get tangled in MRF equipment, resulting in plant shutdowns and/or costly repairs.

Soft plastic waste can also be particularly vulnerable to wind. For example, soft plastics can be blown by wind out of waste bins, leading to problems such as street litter, clogged storm drains, and also contamination of recycling bins meant for other types of materials.

Improvement is desired.

Furthermore, it is important for any solution for collecting soft plastics for recycling be able to be easily integrated into existing systems and processes for collecting and processing materials for recycling.

### SUMMARY

It is proposed to facilitate soft plastic collection via a receptacle that is accessible to multiple households, each of which is supplied with a small household bag that is configured to couple with the receptacle. The receptacle itself contains a large bag for receiving waste inserted into the receptacle via an opening thereof. A small bag is configured to couple with the receptacle so that the small bag is retained on the receptacle around the opening of the receptacle, and the opening of the receptacle and an open end of the small bag are connected. A user can then push the contents of the small bag into the receptacle to empty out the bag. In doing so, the user may cause some compaction of the waste inside the receptacle. The effect of such compaction of the waste inside the receptacle can accumulate as users empty the contents of their small bags into the receptacle. Once the large bag is full, the receptacle may be opened, and the large bag removed for recycling. Advantageously, good compaction of soft plastics may be achieved, which can reduce the cost of collecting soft plastics. Furthermore, it is found that users find it more convenient to use a small bag emptying into a large receptacle rather a large bin in the household that fills up quickly. Finally, the need for powered compaction may be reduced or eliminated.

In some aspects, there is described a kit for a waste collection system. The kit also includes a receptacle, including a vessel defining an opening that opens into an interior of the vessel and at least one drainage aperture separate from the opening to allow gas exchange between the interior and an exterior of the vessel, a valve mounted on to the vessel to mitigate flow of waste from the interior to the exterior via the opening, and a first plurality of retaining elements distributed around the opening exterior to the valve. The kit also includes a first bag mounted in the interior of the vessel around the opening to receive waste via the valve, the first bag being perforated and expandable within the interior to expand as the waste is received into the vessel; and a second bag defining a second plurality of retaining elements complementary to the first plurality of retaining elements to allow the second bag to be retained around the opening, exterior to the valve.

Implementations may include one or more of the following features. The kit where the valve is a restrictor check valve. The vessel defines a lid that is openable to allow removal of the first bag from the vessel. The opening is formed on the lid, and the lid is hinged to allow removal of the first bag from the first bag while the lid is attached to a body of the vessel. The first bag is composed of polyethylene. The first plurality of retaining elements and the second plurality of retaining elements may include a plurality of apertures and a plurality of projections suitable to be complementarily received in the plurality of apertures. The plurality of projections are cylinders, and the plurality of apertures are grommeted apertures formed around an open end of the second bag and suitable to receive the cylinders. The receptacle further may include a plate resiliently mounted in the interior of the vessel to urge the first bag against the opening to compact waste. The plate is resiliently mounted in the interior via one or more resilient members extending from the plate to the vessel to urge the plate towards the opening. The one or more resilient members are three resistance bands attached to the vessel around the opening and around an outer end of the plate to urge the plate towards the opening. The second bag includes a fenestrated body to hold waste.

In some aspects, there is described a waste collection system. The waste collection system also includes a receptacle, including a vessel defining an opening that opens into an interior of the vessel and at least one drainage aperture separate from the opening to allow gas exchange between the interior and an exterior of the vessel, a valve mounted on to the vessel to mitigate flow of waste from the interior to the exterior via the opening, and a first plurality of retaining elements distributed around the opening exterior to the valve. The system also includes a first bag mounted in the interior of the vessel around the opening to receive waste via the valve, the first bag being perforated and expandable within the interior to expand as the waste is received into the vessel; and a second bag, including a fenestrated body to hold waste and defining an open end, and a second plurality of retaining elements distributed around the open end and complementary to the first plurality of retaining elements to retain the second bag around the opening exterior to the valve.

Implementations may include one or more of the following features. The waste collection system where the valve is a restrictor check valve. The vessel defines a lid that is openable to allow removal of the first bag from the vessel. The opening is formed on the lid, and the lid is hinged to allow removal of the first bag from the first bag while the lid is attached to a body of the vessel.

The first bag is composed of polyethylene. The first plurality of retaining elements and the second plurality of retaining elements may include a plurality of apertures and a plurality of projections suitable to be complementarily received in the plurality of apertures. The plurality of projections are cylinders, and the plurality of apertures are grommeted apertures formed around an open end of the second bag and suitable to receive the cylinders. The receptacle further may include a plate resiliently mounted in the interior of the vessel to urge the first bag against the opening to compact waste. The plate is resiliently mounted in the interior via one or more resilient members extending from the plate to the vessel to urge the plate towards the opening. The one or more resilient members are three resistance bands attached to the vessel around the opening and around an outer end of the plate to urge the plate towards the opening.

In some aspects. there is described a waste receptacle. The waste receptacle also includes a vessel defining an opening that opens into an interior of the vessel and at least one drainage aperture separate from the opening to allow gas exchange between the interior and an exterior of the vessel; a valve mounted on to the vessel to mitigate flow of waste from the interior to the exterior via the opening; and a first plurality of retaining elements distributed around the opening exterior to the valve and complementary to a second plurality of retaining elements on a second bag to allow the second bag to be retained around the opening, exterior to the valve, where a first bag is mounted in the interior of the vessel around the opening to receive waste via the valve, the first bag being perforated and expandable within the interior to expand as the waste is received into the vessel.

Implementations may include one or more of the following features. The waste receptacle where the valve is a restrictor check valve. The vessel defines a lid that is openable to allow removal of the first bag from the vessel. The opening is formed on the lid, and the lid is hinged to allow removal of the first bag from the first bag while the lid is attached to a body of the vessel. The first bag is composed of polyethylene. The first plurality of retaining elements and the second plurality of retaining elements may include a plurality of apertures and a plurality of projections suitable to be complementarily received in the plurality of apertures. The plurality of projections are cylinders. The receptacle further may include a plate resiliently mounted in the interior of the vessel to urge the first bag against the opening to compact waste. The plate is resiliently mounted in the interior via one or more resilient members extending from the plate to the vessel to urge the plate towards the opening. The one or more resilient members are three resistance bands attached to the vessel around the opening and around an outer end of the plate to urge the plate towards the opening.

In some aspects, there is described a method of operating a waste collection system. The method also includes anchoring a first bag around an opening of a vessel; and causing waste from the first bag to be received into a second bag mounted inside the vessel while the first bag is anchored around the opening of the vessel.

Implementations may include the following feature. The method, where causing waste from the first bag to be received into a second bag mounted inside the vessel includes everting the first bag into the opening of the vessel to draw waste from the first bag into the second bag via the opening. Further details of these and other aspects of the subject matter of this application will be apparent from the detailed description included below and the drawings.

### DESCRIPTION OF THE DRAWINGS

Reference is now made to the accompanying drawings, in which:

FIG. 1A is a side cross-sectional view of a kit for a waste collection system, in accordance with an embodiment;

FIG. 1B is a front elevation view, showing the receptacle of the waste collection system.

FIG. 2A is a schematic view of the waste collection system in a first stage of operation, in accordance with an embodiment;

FIG. 2B is a schematic view of the waste collection system in a second stage of operation, in accordance with an embodiment;

FIG. 2C is a schematic view of the waste collection system in a third stage of operation, in accordance with an embodiment;

FIG. 2D is a schematic view of the waste collection system in a fourth stage of operation, in accordance with an embodiment;

FIG. 2E is a schematic view of the waste collection system in a fifth stage of operation, in accordance with an embodiment;

FIG. 3 is a partial top plan view of a receptacle in an open position in a sixth stage of operation of the waste collection system, in accordance with an embodiment;

FIG. 4 is an exploded view of the receptacle, in accordance with an embodiment;

FIG. 5A is a side cross-sectional view of a receptacle, in accordance with another embodiment;

FIG. 5B is a view of the section indicated by the line 5B-5B in FIG. 5A;

FIG. 5C is a view of the section indicated by the line 5C-5C in FIG. 5A;

FIG. 5D is a schematic exploded view of the receptacle in FIG. 5A;

FIG. 5E is an enlarged view of the region 5E in FIG. 5B;

FIG. 6A is a schematic side cross-sectional view of a receptacle, in accordance with another embodiment;

FIG. 6B is a front elevation view of the receptacle of FIG. 6A;

FIG. 7A is a front elevation view of a support bracket for the receptacle, in accordance with an embodiment;

FIG. 7B is a side elevation view of the support bracket;

FIG. 8A is a top plan view of the support bracket having a receptacle mounted thereon;

FIG. 8B is a side elevation view of the support bracket mounted to a vehicle and having a receptacle mounted thereon.

FIG. 9A is a front elevation of a support bracket, in accordance with another embodiment;

FIG. 9B is a side elevation of the support bracket;

FIG. 10 is a side elevation view of the vessel mounted on a vehicle, in accordance with an embodiment;

FIG. 11A is a left side elevation view of a vessel mounted on a vehicle using a mounting system that is positioned in an extended or deployed position, in accordance with another embodiment;

FIG. 11B is a right-side elevation view of the vessel as mounted on the vehicle using the mounting system of FIG. 11A;

FIG. 11C is a rear elevation view of the vessel as mounted on the vehicle using the mounting system of FIG. 11A;

FIG. 11D is a side elevation view of the vessel as mounted on the vehicle using the mounting system of FIG. 11A, where the mounting system is positioned in a retracted position while the vehicle is positioned for release of waste;

FIG. 11E is a side elevation view of the vessel illustrating a variety of positions that the vessel can be selectively placed in;

FIG. 12A is a schematic view of the small bag prior to being assembled, in accordance with an embodiment;

FIG. 12B is a view of the small bag in a collapsed state, in accordance with an embodiment;

FIG. 12C is a view of the small bag in an expanded state, in accordance with an embodiment;

FIG. 13A illustrates a first step of production of a small bag, in accordance with an embodiment;

FIG. 13B illustrates a second step of production of the small bag, in accordance with an embodiment;

FIG. 13C illustrates a third step of production of the small bag, in accordance with an embodiment;

FIG. 13D illustrates a fourth step of production of the small bag, in accordance with an embodiment;

FIG. 13E illustrates a fifth step of production of the small bag, in accordance with an embodiment;

FIG. 13F illustrates a sixth step of production of the small bag, in accordance with an embodiment;

FIG. 13G illustrates a seventh step of production of the small bag, in accordance with an embodiment;

FIG. 13H is a front elevation view of the finished small bag, in accordance with an embodiment;

FIG. 13I is a perspective view of the finished small bag, in accordance with an embodiment;

FIG. 13J is a perspective view of the finished small bag with an optional pocket attached, in accordance with an embodiment; and

FIG. 14 is an example flow chart of a method of operating a waste collection system.

### DETAILED DESCRIPTION

The following disclosure relates to a waste collection system and a kit therefor. The kit comprises a receptacle, a first bag, and a second bag. The receptacle includes a vessel defining an opening that opens into an interior of the vessel and at least one drainage aperture separate from the opening to allow gas exchange between the interior and an exterior of the vessel, a valve mounted on to the vessel to mitigate flow of waste from the interior to the exterior via the opening, and a first plurality of retaining elements distributed around the opening exterior to the valve. The first bag is mounted in the interior of the vessel around the opening to receive waste via the valve. The first bag is further perforated and expandable within the interior to expand as the waste is received into the vessel. The second bag defines a second plurality of retaining elements complementary to the first plurality of retaining elements to allow the second bag to be retained around the opening, exterior to the valve. The second bag can include a fenestrated body to hold waste and defining an open end, and a second plurality of retaining elements distributed around the open end and complementary to the first plurality of retaining elements to retain the second bag around the opening exterior to the valve. A method of operating a waste collection system is disclosed, which comprises anchoring a first bag around an opening of a vessel; and causing waste from the first bag to be received into a second bag mounted inside the vessel while the first bag is anchored around the opening of the vessel.

Aspects of various embodiments are described in relation to the figures.

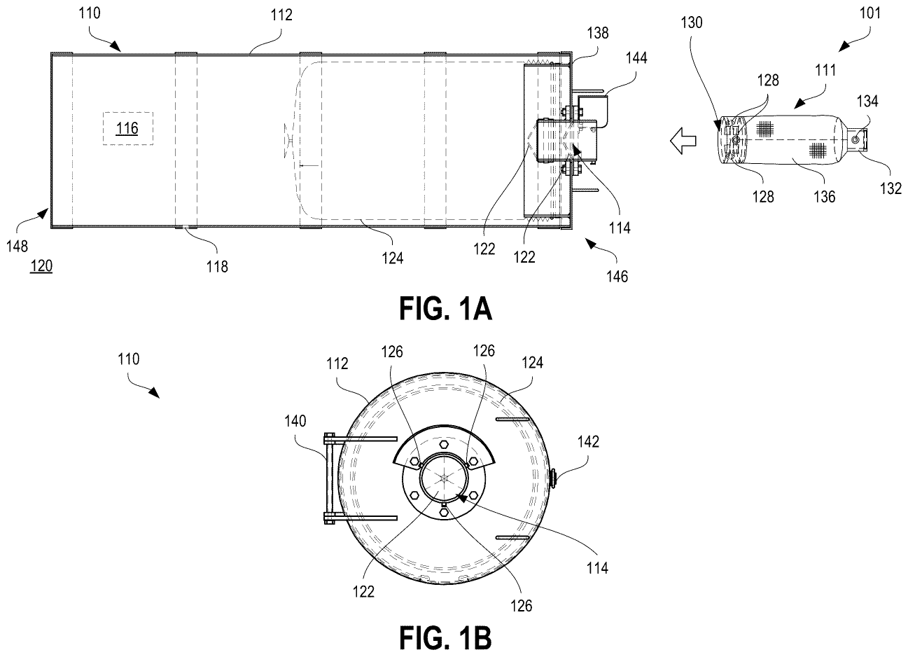

FIG. 1A is a side cross-sectional view of a kit 101 for a waste collection system 100, in accordance with an embodiment. FIG. 1B is a front elevation view, showing the receptacle 110 of the waste collection system 100.

The waste collection system 100 comprises a (waste) receptacle 110 and a small (waste) bag 111.

The small bag 111 comprises a fenestrated body 136 for holding waste. The fenestrated body 136 defines an open end 130 and may be flexible. The fenestrated body 136 is pervious to allow gas exchange between an interior of the small bag 111 and an exterior thereof. For example, the fenestrated body 136 may be formed of a mesh fabric or textile. In some embodiments, the fenestrated body 136 may be formed of a durable polymer (plastic) mesh so as to allow re-use.

The small bag 111 comprises a tab 132 formed at an end or terminal end of the small bag 111. For example, the small bag 111 may define a circular cross-section with a 200 mm diameter and may define a length (or depth) of 500 mm. The tab 132 may have formed therein an aperture 134.

The small bag 111 may be a bag suitable for an end user. In various embodiments, the small bag 111 may be used to line an existing waste bin. For example, the small bag 111 may be placed in a user's home to allow a user to place waste soft plastics (or other waste) therein. Once the soft plastics have filled up the small bag 111, the small bag 111 may be emptied into the receptacle 110 as will be described later.

The receptacle 110 comprises a vessel 112. The vessel 112 defines an opening 114 that opens into an interior 116 of the vessel 112. The vessel 112 defines at least one drainage aperture 118 separate from the opening 114 to allow gas exchange between the interior 116 and an exterior 120 of the vessel 112. The drainage aperture 118 also allow drainage of moisture from the vessel 112 that may condense therein or otherwise infiltrate thereinto. For example, water may infiltrate into the vessel 112 during rainfall.

The receptacle 110 further comprises one or more valves 122. The valves 122 are mounted on to the vessel 112 to mitigate flow of waste from the interior 116 to the exterior 120 via the opening 114. In some embodiments, the valve 122 may be a check valve suitable to allow waste into the vessel 112 via the opening 114 while preventing or mitigating reverse flow therefrom. In various embodiments, a valve may comprise a plurality of valve elements. The valve elements may be relatively flat and may extend inwardly from a peripheral end of the opening 114 towards a center thereof. The valve elements may be inclined inwardly, towards the interior 116, and pivotable towards the interior to allow waste to be pushed into the interior 116. The valve elements may be composed of rubber or other flexible material. In some embodiments, the valve elements may overlap to prevent egress of waste. In some embodiments, the valve 122 may be formed of a planar sheet of flexible material, such as rubber, that has one or more slits cut therein to a user to push in material therethrough in at least one direction.

The receptacle 110 further comprises a large (waste) bag 124 mounted in the interior 116 of the vessel 112 around the opening 114 to receive waste via the valve 122. The large bag 124 is perforated and expandable within the interior 116 to expand as the waste is received into the vessel 112, as illustrated in FIG. 1A. For example, the large bag 124 may be a polyethylene bag. The large bag 124 may be relatively flat and adhered to itself so as to provide resistance to expansion. Advantageously, the resistance may facilitate packing of waste as users push waste into the large bag 124.

As the large bag 124 expands within the interior 116, gas and moisture within the large bag 124 may be drawn out of the large bag 124 and then out of the vessel 112 via the drainage aperture 118. Advantageously, this may facilitate drying of wet soft plastics in the large bag 124. For example, as the soft plastics in the large bag 124 are compressed, e.g. by a user emptying waste into the large bag 124, moisture is separated from the soft plastic material in the large bag 124, which moisture is then drawn out of the vessel 112 via drainage aperture 118.

The receptacle 110 further comprises a plurality of retaining elements 126 or anchors distributed around the opening 114 exterior to the valve 122. The plurality of retaining elements 126 are complementary to another plurality of retaining elements 128 on the small bag 111 to allow the small bag 111 to be retained around the opening 114, exterior to the valve 122.

In various embodiments, the first plurality of retaining elements 126 and the second plurality of retaining elements 128 comprise a plurality of apertures and a plurality of projections suitable to be complementarily received in the plurality of apertures.

For example, in the embodiment shown in FIG. 1A-1B, the first plurality of retaining elements 126 is a plurality of projections and the second plurality of retaining elements 128 is a complementary plurality of apertures. In other embodiments, the first plurality of retaining elements 126 is a plurality of apertures and the second plurality of retaining elements 128 is a complementary plurality of projections. In some embodiments, the first plurality of retaining elements 126 includes one or more projections and one or more apertures, and the second plurality of retaining elements 128 includes a complementary one or more apertures and a complementary one or more projections, respectively.

In various embodiments, the plurality of apertures are grommeted apertures formed and distributed around the open end 130 for receiving the plurality of retaining elements 128. In some embodiments, the plurality of projections are cylinders, and the plurality of apertures are grommeted apertures formed suitable to receive the cylinders.

In various embodiments, the vessel 112 further defines a lid 138 that is openable to allow removal of the large bag 124 from the vessel 112. The lid 138 may be hingeably or pivotably mounted to a body of the vessel 112 so as to form a door to provide access to the interior 116. The lid 138 may be so mounted at a head end 146 of the vessel 112 and/or the receptacle 110. For example, the lid 138 may be hinged to the body of the vessel 112 via hinges 140 to allow removal of the large bag 124 from the vessel 112 while the lid 138 is attached to the body of the vessel 112. In various embodiments, a latch 142 may be provided to retain and/or lock the lid 138 in place and prevent opening of the vessel 112.

In various embodiments, the opening 114 may be formed on the lid 138. For example, the opening 114 may be formed by a hole passing through the lid 138.

In various embodiments, a guard 144 may be formed over an exterior end of the opening 114. The guard 144 may be a weather guard suitable to mitigate moisture ingress into the vessel 112. For example, the guard 144 may prevent moisture from entering into the vessel 112 while a user is inserting waste into the vessel 112.

In various embodiments, the vessel 112 may cylindrically shaped with a circular cross-sectional of diameter 0.7 m and an axial length of 2 m to 2.5. The vessel 112 may be constructed of sheet metal with band stiffeners axially distributed along the vessel 112 to stiffen the structure of the vessel 112, as shown. In some embodiments, the vessel 112 may have a square, rectangular, or other polygonal cross-section while being elongated normal to said cross-section.

In various embodiments, the vessel 112 may be constructed of elongated sheet metal bent to form a generally tubular that is then capped at tail end of the vessel 112. In various embodiments, the tail end 148 of the vessel is opposite to the head end 146 of the vessel 112.

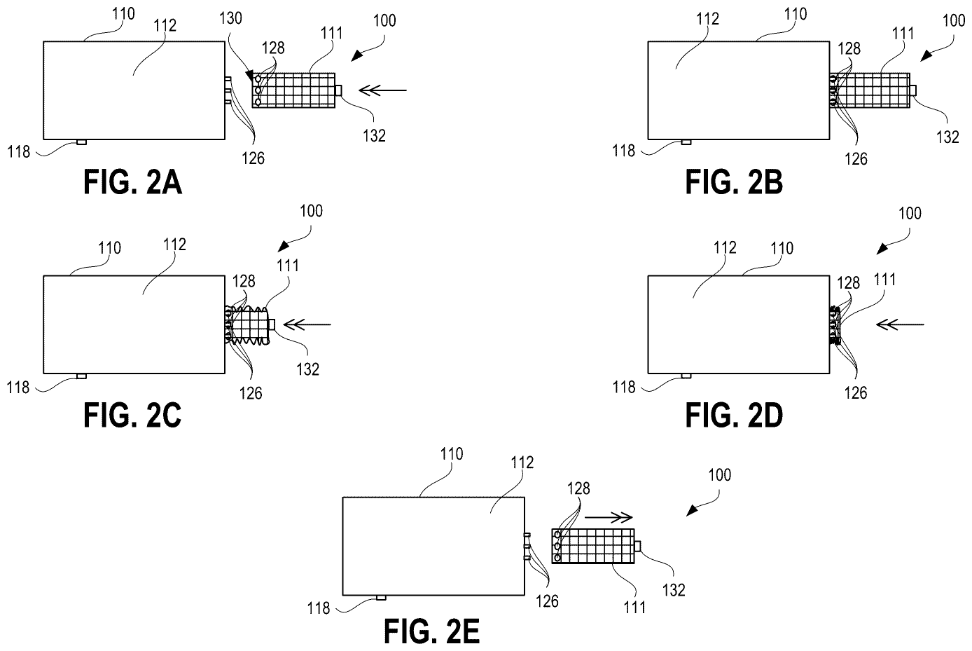

FIG. 2A is a schematic view of the waste collection system 100 in a first stage of operation, in accordance with an embodiment.

In the first stage of operation, the receptacle 110 and the small bag 111 may be disconnected and separate from each other. The small bag 111 may be placed in a user's home to be filled with waste.

FIG. 2B is a schematic view of the waste collection system 100 in a second stage of operation, in accordance with an embodiment.

In the second stage of operation, the small bag 111 is attached to the receptacle 110 so that the open end 130 of the small bag 111 is oriented towards (or opens to) the opening 114 of the receptacle 110 in preparation of transfer of waste from the small bag 111 to the large bag 124. The small bag 111 may be attached to and retained on the receptacle 110 by means of complementary retaining elements 126, 128, e.g. formed so as to mate or engage with each other. In the embodiment of FIG. 2B, projections of the receptacle 110 extend outwardly and engage with apertures of the small bag 111. In some embodiments, projections of the small bag 111 may engage with apertures of the receptacle 110.

FIG. 2C is a schematic view of the waste collection system 100 in a third stage of operation, in accordance with an embodiment.

In the third stage of operation, an end of the small bag 111 opposite to the open end 130 or an end of the small bag 111 distal from the vessel 112 is pushed towards the vessel 112 to push the contents thereof into the large bag 124. As the small bag 111 is pushed in this manner, it remains attached to the receptacle 110 by the retaining elements 126, 128.

FIG. 2D is a schematic view of the waste collection system 100 in a fourth stage of operation, in accordance with an embodiment.

In the fourth stage of operation, the small bag 111 is pushed by a user until the waste therein is completely emptied into the vessel 112.

In some embodiments, the small bag 111 may compressed while remaining outside vessel 112. In some embodiments, the small bag 111 may be pushed into the vessel 112 by everting thereinto.

Advantageously, as the small bag 111 is being compressed or otherwise pushed in towards the vessel 112, the pressure inside and outside the small bag 111 is equalized since the small bag 111 is fenestrated.

Advantageously, as the waste in the small bag 111 is pushed into the large bag 124 in the vessel, any waste previously present in the large bag 124 may be further compressed due to pushing by the user. For example, this may be particularly advantageous for efficient collection soft plastics that may be deformed into more compact forms for collection. Advantageously, a significant compaction of soft plastics may be achieved by relying on user efforts, e.g. without the use of powered compactors.

As waste is pushed into the vessel 112, the large bag 124 expands and pushes gas (air) in the vessel 112 out via the drainage aperture 118 so as to cause pressurize equalization between the interior 116 and the exterior 120 to facilitate filling of waste into the large bag 124.

FIG. 2E is a schematic view of the waste collection system 100 in a fifth stage of operation, in accordance with an embodiment.

In the fifth stage of operation, the small bag 111 (an end thereof) is drawn away from the vessel 112 and detached therefrom by detaching of the retaining elements 126, 128. Advantageously, the small bag 111 may be drawn away from the vessel 112 by use of the tab 132. In some embodiments, the aperture 134 of the tab 132 may be used to pull the small bag 111 away from the vessel 112. Advantageously, the tab 132 may facilitate everting of the small bag 111 into the vessel 112. For example, in embodiments where the small bag 111 is everted into the vessel 112, the small bag 111 is pulled out of the vessel 112 by means of the tab 132.

Advantageously, in various embodiments, while the small bag 111 is pulled out of the vessel 112, its pervious (or gas permeable) nature causes pressure equalization, which mitigates formation of a vacuum or low pressure zone within the small bag 111. For example, inadvertent (vacuum) suction of soft plastics out of the vessel 112 is mitigated.

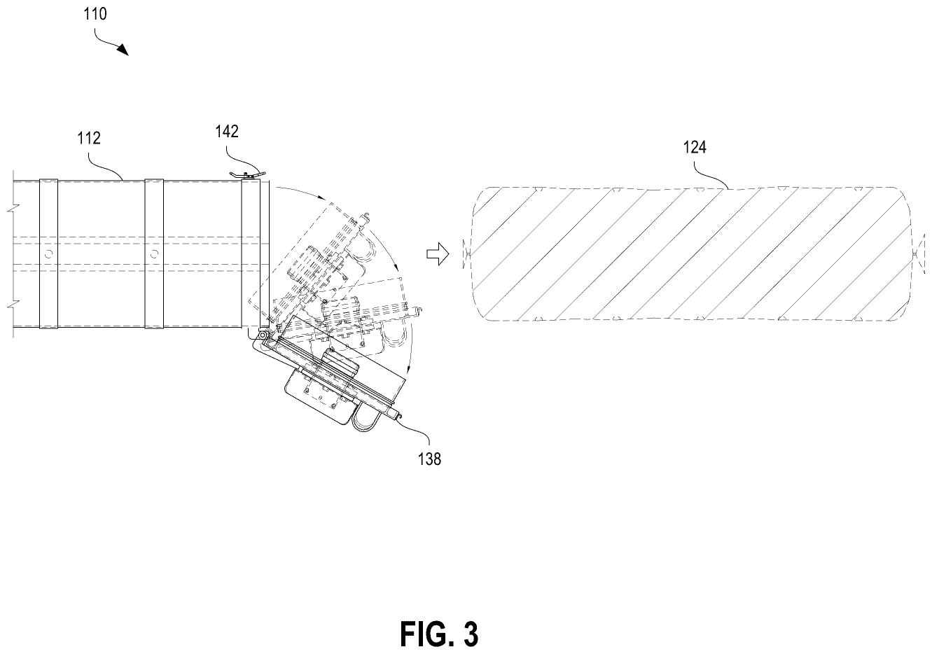

FIG. 3 is a partial top plan view of the receptacle 110 in an open position in a sixth stage of operation of the waste collection system 100, in accordance with an embodiment.

When the large bag is sufficiently full, the lid 138 is opened and the full large bag 124 is drawn out to be taken for the next stage of processing. Advantageously, soft plastics may be collected from a multiple homes and offices by using a single receptacle 110 and a plurality of small bags 111, with each home or office being provided with a small bag 111. The collection of soft plastics may be made particularly efficient by such a single point of collection. Furthermore, the use of valves may prevent egress of waste and also serve as a deterrent to users intending to insert (large) rigid objects into the vessel 112.

The full large bag 124 may be removed by a waste collection specialist and transported by vehicle, or remove at a processing facility, as will be described later.

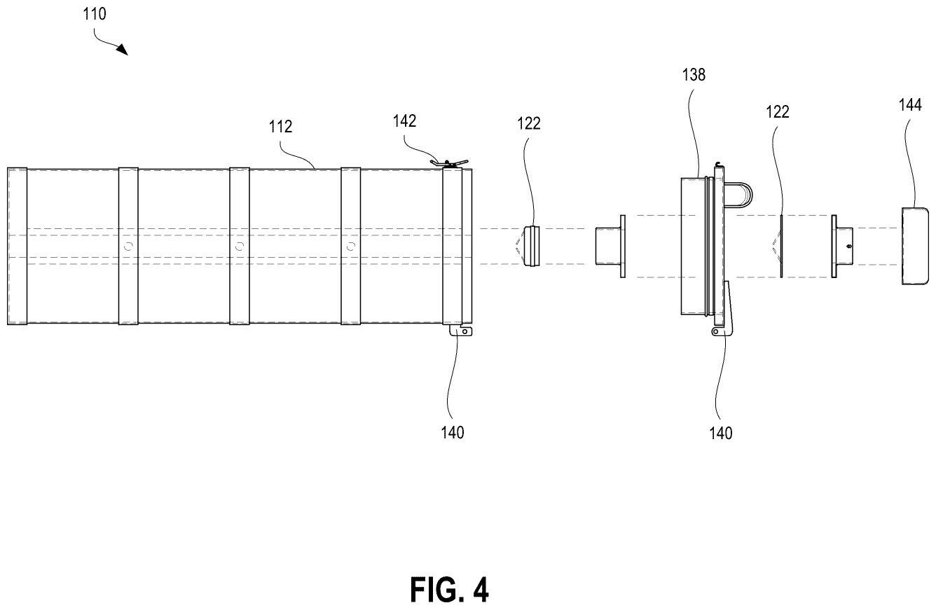

FIG. 4 is an exploded view of the receptacle 110, in accordance with an embodiment.

As shown in FIG. 4, the retaining elements may be provided by an exterior pipe casing. An additional interior pipe casing may also be provided. The lid 138 may further comprising pipe casing, fasteners for fastening the large bag 124 (e.g. poly tube fasteners), and support racks for accessories.

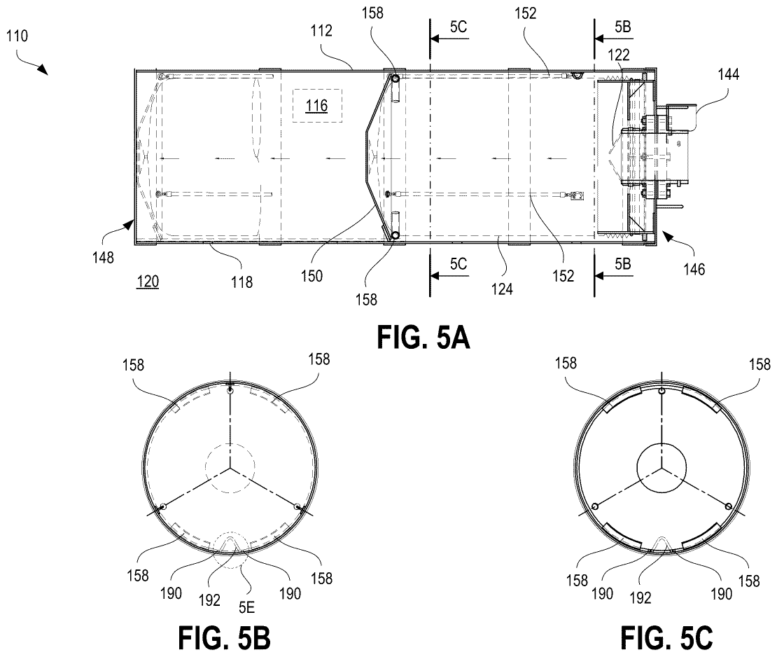

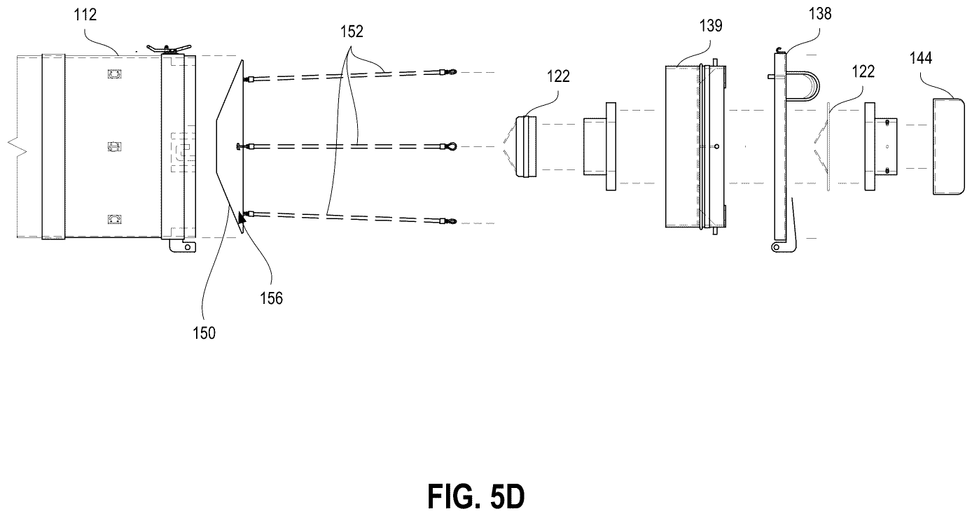

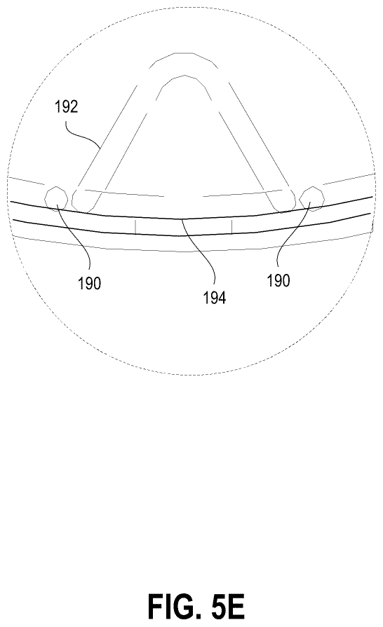

FIG. 5A is a side cross-sectional view of a receptacle 110, in accordance with another embodiment.

FIG. 5B is a view of the section indicated by the line 5B-5B in FIG. 5A.

FIG. 5C is a view of the section indicated by the line 5C-5C in FIG. 5A.

FIG. 5D is a schematic exploded view of the receptacle 110 in FIG. 5A.

FIG. 5E is an enlarged view of the region 5E in FIG. 5B.

The receptacle 110 in FIG. 5A comprises a plate 150 resiliently mounted in the interior 116 of the vessel 112 to urge the large bag 124 against the opening 114 to compact waste.

In FIG. 5A, an expanded position of the large bag 124 where the plate 150 is pushed backwards away (see arrows in FIG. 5A indicating the movement of the plate 150) from the opening 114 is illustrated in broken line.

The plate 150 is resiliently mounted in the interior 116 via one or more resilient members 152 extending from the plate 150 to the vessel 112 to urge the plate 150 towards the opening 114.

The resilient members 152 may be mounted to the vessel 112 via eyelets attached to an interior circumferential wall of the vessel 112.

In the embodiments of FIG. 5A-5D, the one or more resilient members 152 are (or include at least) three resistance bands attached to the vessel 112 around the opening 114 and around an outer end 156 of the plate 150 to urge the plate towards the opening 114. In some embodiments, the one or more resilient members 152 are four resistance bands attached to the vessel 112. For example, four resistance bands may be used in embodiments when the vessel 112 is substantially a rectangular cuboid (or cuboid-shaped).

A plurality of stops 158 may be distributed around the plate 150 to support the large bag 124 against the plate 150.

Casing 139 may be provided to fasten the large bag 124 therewith to the vessel 112. As shown in FIG. 5D, the lid 138 and the casing 139 defining bag fasteners for the large bag 124 may be separate components.

Advantageously, the use of the plate 150 facilitates compacting of the waste. Furthermore, the material and dimensions of the resilient bands may be chosen to achieve a desired backpressure or force against the large bag 124 so as to aid in compaction, such compaction being provided by a user pushing against the plate 150 via waste being inserted into the vessel 112. Advantageously, user convenience (or ease of use) and compaction may be traded off to achieve desired objectives.

A carriage 192 is attached to the plate 150. The carriage 192 may be attached to a rear end of the plate 150, opposite to the large bag 124. The carriage 192 may comprise two legs and may be in the form of an inverted V-shape. The carriage 192 is held captive (or retained) between two (linear) guides 190 for sliding along a slideway 194 defined therebetween. The guides 190 extend longitudinally along the vessel 112 to keep the carriage 192 retained between the guides 190 as the plate 150 moves along the vessel 112. The guides 190 may be mounted on to a wall of the vessel 112. For example, the guides 190 may be attached to a base or floor of the vessel 112.

Advantageously, the carriage 192 and the guides 190 ensure that the plate 150 remains aligned as the large bag 124 expands and the plate 150 is pushed away from lid 138.

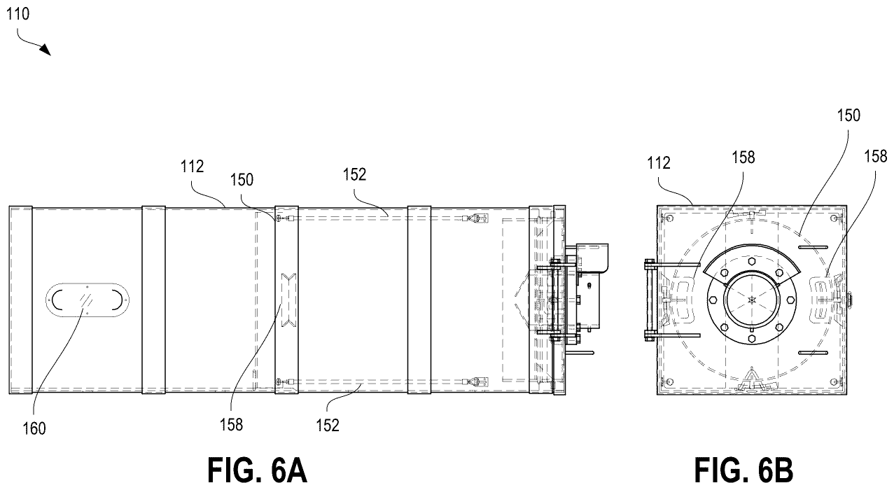

FIG. 6A is a schematic side cross-sectional view of a receptacle 110, in accordance with another embodiment.

FIG. 6B is a front elevation view of the receptacle 110 of FIG. 6A. The positions of the plate 150 and the stops 158 are indicated in broken line in FIG. 6B.

In the embodiment of FIGS. 6A-6B, the vessel 112 has a square cross-section, the stops 158 comprise two stops antipodally positioned about the plate 150, and a view port 160. The view port 160 may be provided to allow a user to examine the progress of waste filling of the large bag 124.

The view port 160 may comprise a transparent or translucent material forming a window for a user to view the interior 116.

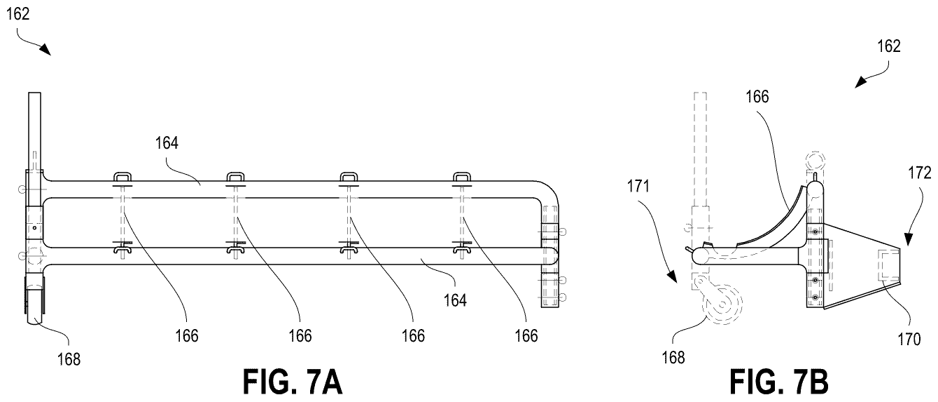

FIG. 7A is a front elevation view of a support bracket 162 for the receptacle 110, in accordance with an embodiment.

FIG. 7B is a side elevation view of the support bracket 162.

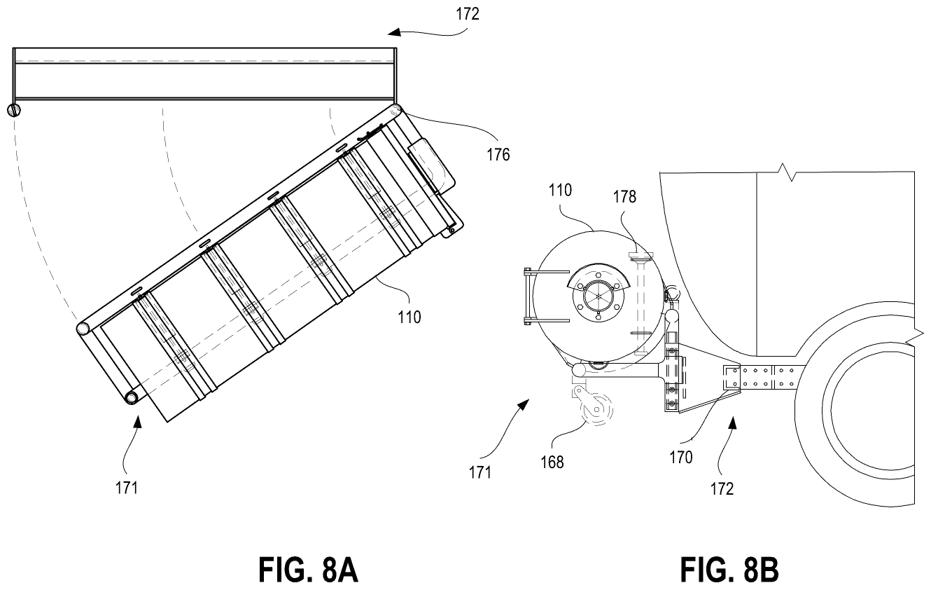

FIG. 8A is a top plan view of the support bracket 162 having a receptacle 110 mounted thereon.

FIG. 8B is a side elevation view of the support bracket 162 mounted to a vehicle and having a receptacle 110 mounted thereon.

Referring to FIGS. 7A-7B, 8A-8B, the support bracket 162 comprises a plurality of bars 164 extending longitudinally to support the receptacle 110 thereon. A plurality of ribs 166 extend laterally in between the plurality of bars 164 to further support the receptacle 110. The each of the plurality of ribs 166 may be arcuate to conform to a (portion of a) surface of the vessel 112. In some embodiments, each of the plurality of ribs 166 may comprise two linear sections perpendicular to each other to conform to a surface of a vessel 112 with a rectangular cross-section.

The vessel 112 may be mounted on to the support bracket 162 after the large bag 124 or may be left thereon while the large bag 124 is being filled.

A rear end 171 of the support bracket 162 comprises a wheel 168. The wheel 168 may be mounted at a lateral end of the support bracket 162, while an opposite lateral end of the support bracket 162 may define a hinge 176 suitable to swing the plurality of bars 164 and the plurality of ribs 166 away from the front end 172. As illustrated in FIG. 8A, the wheel 168 and the hinge 176 allows the receptacle 110 to be swung away from the front end 172 while being supported by the plurality of bars 164 and the plurality of ribs 166.

A front end 172 of the support bracket 162 may comprise a coupler 170 for coupling the support bracket 162 to a vehicle, as illustrated in FIG. 8B. The coupler 170 may comprise a receiver or a mounting projection for mating to a corresponding mounting projection or receiver of the vehicle, respectively. Advantageously, a waste collection vehicle can collect the receptacle 110 rapidly and efficiently by mounting on the vehicle via the coupler 170.

A push bar accessory 178 is provided with the receptacle 110 to facilitate compaction of soft plastics inside the vessel 112.

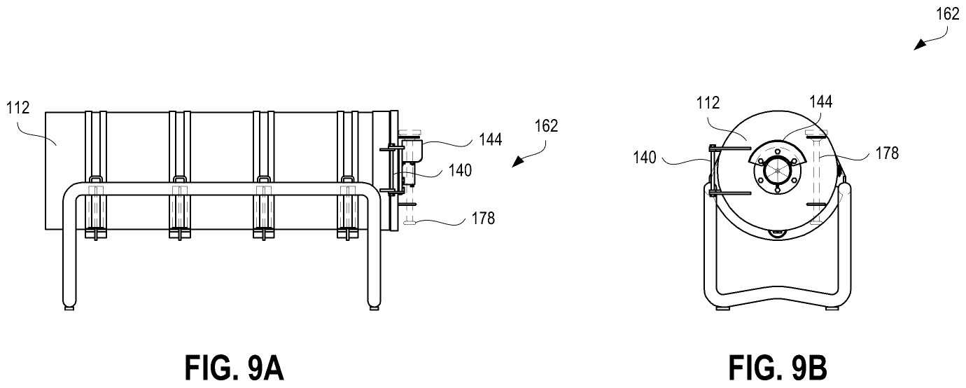

FIG. 9A is a front elevation of a support bracket 162, in accordance with another embodiment.

FIG. 9B is a side elevation of the support bracket 162.

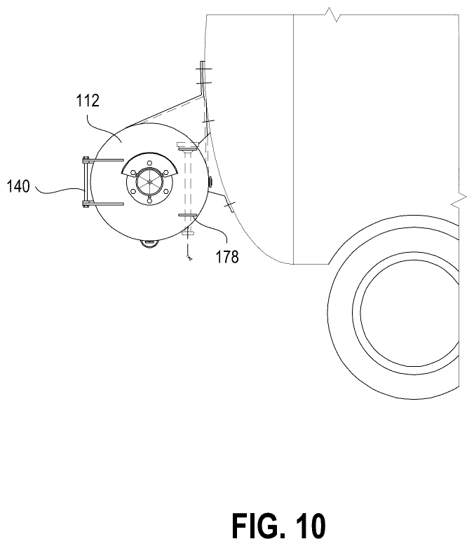

FIG. 10 is a side elevation view of the vessel 112 mounted on a vehicle, in accordance with an embodiment.

In the embodiments of FIGS. 9A-9B, the support bracket 162 is not provided with wheels. Instead, the support bracket 162 rests on fixed legs. Additionally, a push bar accessory 178 is provided with the receptacle 110 to facilitate compaction of soft plastics inside the vessel 112.

As shown in FIG. 10, the vessel 112 may be removed from the support bracket 162 and supported on a collection vehicle. For example, the vessel 112 may be supported by means of stapping.

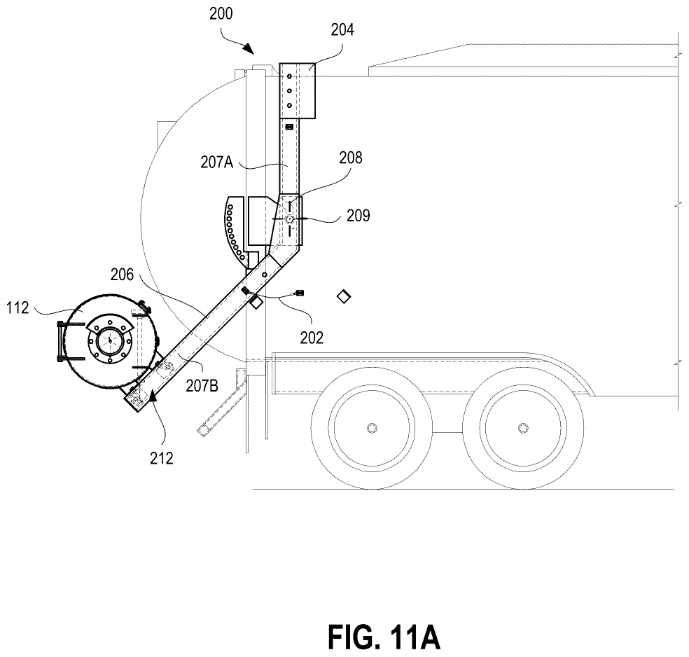

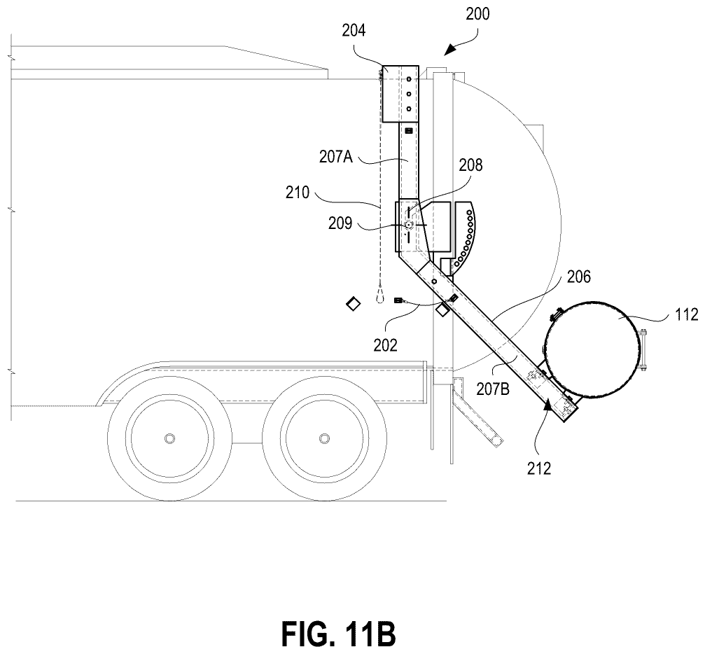

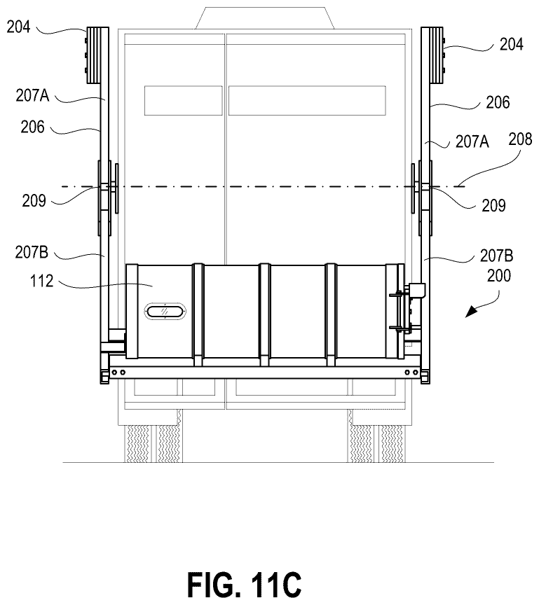

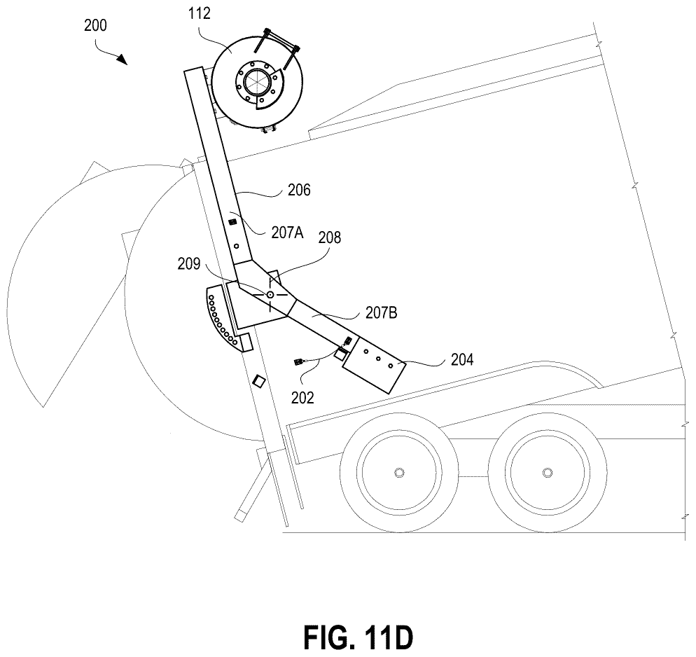

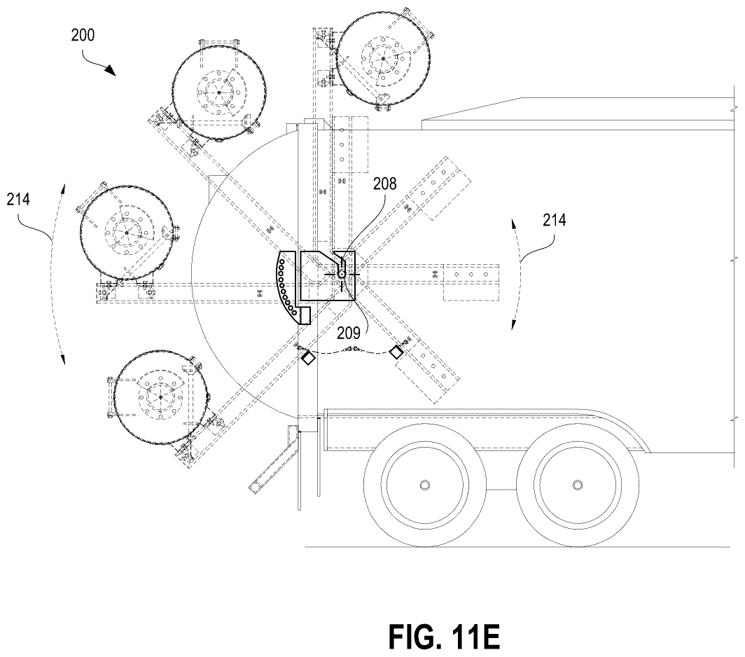

FIG. 11A is a left side elevation view of the vessel 112 mounted on a vehicle using a mounting system 200 that is positioned in an extended or deployed position, in accordance with another embodiment.

FIG. 11B is a right-side elevation view of the vessel 112 as mounted on the vehicle using the mounting system 200 of FIG. 11A.

FIG. 11C is a rear elevation view of the vessel 112 as mounted on the vehicle using the mounting system 200 of FIG. 11A.

FIG. 11D is a side elevation view of the vessel 112 as mounted on the vehicle using the mounting system 200 of FIG. 11A, where the mounting system 200 is positioned in a retracted position while the vehicle is positioned for release of waste.

Referring to FIGS. 11A-11D, the mounting system 200 may define a bascule-like mechanism. The mounting system 200 comprises a lever 206 mounted on the vehicle so as to pivot about pivot axis 208.

The lever 206 may define a pair of arms elongated so as to allow (terminal) ends of the lever 206 to pivot over and away from a rear of the vehicle. In some embodiments, the lever 206 may consist of a single pivoting arm.

The lever 206 may comprise a first portion 207A defined on a first side of the pivot axis 208 and a second portion 207B defined on a second side of the pivot axis 208 opposite the first 207A. The first and second portions 207A, 207B may each be an elongated member defining a respective elongation direction along a corresponding longitudinal axis thereof. In various embodiments, the (elongation direction of the) second portion 207B may be angled relative to the (elongation direction of the) first portion 207A, as illustrated in FIGS. 11A-11B. The second portion 207B may be angled about the pivot axis 208 relative to the first portion 207A. In various embodiments, the second portion 207B may be angled between 0° and 90° relative to the first portion 207A. It is found to be particularly advantageous for the second portion 207B to be angle at substantially 45° relative to the first portion 207A.

The pivot axis 208 is generally horizontal to allow rotation of the lever 206 thereabout, which then moves ends of the lever 206 vertically, towards and away from the ground.

For example, the pivot axis 208 may be defined as a line passing through two mounting points 209. The two mounting points 209 may be positioned at a side of the vehicle so that the pivot axis 208 passes through a portion of the vehicle.

In some embodiments, the pivot axis 208 may be spaced apart from the vehicle. For example, a pair of spacers defining a corresponding pair of mounting points may be attached to the vehicle (away from the pair of mounting points) to allow pivotable attachment of the lever 206 to the spacers, via the mounting points thereof, to define a pivot axis 208 spaced apart from the vehicle.

A first end (or holder end) of the levers 206 may define a holder 212 for retainably holding the vessel 112. A second end (or counterweight end) of the levers 206 opposite the first end defines one or more counterweights 204. A pull cable 210 is attached to the counterweights 204.

Pulling down on the pull cable 210 draws the first end of the lever 206 and the vessel 112 away from the ground by pulling the counterweights 204 down. In particular, pulling down on the pull cable 210 moves the mounting system 200 from a deployed position shown in FIG. 11A-11C to the retracted position shown in FIG. 11D. On the other hand, the mounting system 200 may be moved from the retracted position to the deployed position by pushing the holder end of the lever 206 away from the ground to allow the moment generated by the counterweights 204 to cause rotation of the lever 206 to move the holder end away from the ground while bringing the counterweight end of the lever 206 towards the ground.

The mounting system 200 includes a tether 202. A first end of the tether 202 is attached to the vehicle or other non-rotating portion of the mounting system 200 and/or the vehicle. A second end of the tether 202, opposite the first end of the of tether 202, is selectively attachable to the lever 206 to allow selective mitigation of rotation of the lever 206.

During operation, the second end of the tether 202 is detached or placed in a free position to allow rotation of the lever 206 about the pivot axis 208 between the deployed and retracted positions. Once the desired position of the lever 206 is achieved, the tether 202 is attached to mitigate rotation of the lever 206 to hold the lever 206 in the desired position.

FIG. 11E is a side elevation view of the vessel 112 illustrating a variety of positions that the vessel 112 can be placed in by rotation of the lever 206, as indicated by the double-headed arrow 214.

In FIG. 11E, reference numerals indicating the tether 202, the counterweights 204, the lever 206, and the vessel 112 are omitted to avoid obfuscating the schematic illustration.

In various embodiments, the vehicle is a waste collection vehicle with a waste collection opening positioned at a rear of the vehicle. A user may mount the vessel 112 to the mounting system 200 by moving the mounting system 200 into the deployed position (including tethering the lever 206), then attaching the vessel 112 on to the holder end of the lever 206, releasing the tether 202, and then stowing the vessel 112 away by moving the mounting system 200 into the retracted position (including tethering the lever 206) by pushing the vessel 112 away from the ground to allow the counterweight 204 to cause rotation of the lever arm 206. Once the vessel 112 is stowed, the rear of the vehicle is accessible for receiving and release waste therefrom, e.g. as illustrated in FIG. 11D.

In some embodiments, a motor may be coupled to the lever 206. In some embodiments, the motor is configured to impart rotation and may be coupled to the lever 206 at the pivot axis 208, e.g. by drivably coupling the motor to a rotatable shaft defining the pivot axis 208 and attached to the lever 206. Driving the motor in a forward or reverse direction may then allow movement of the mounting system 200 between the deployed and retracted positions. In various embodiments, the motor may be actuatable by a controller connected thereto. The controller may include an input device, e.g. graphical user interface and/or button for receiving a user input indicative of a direction of rotation of the lever arm 206, e.g. in the form of data indicative of a desired position of the mounting system 200 and/or the vessel 112. The controller may then actuate the motor based on the user input.

In various embodiments, a motorized lever arm 206 as described above may be used with any counterweights 204.

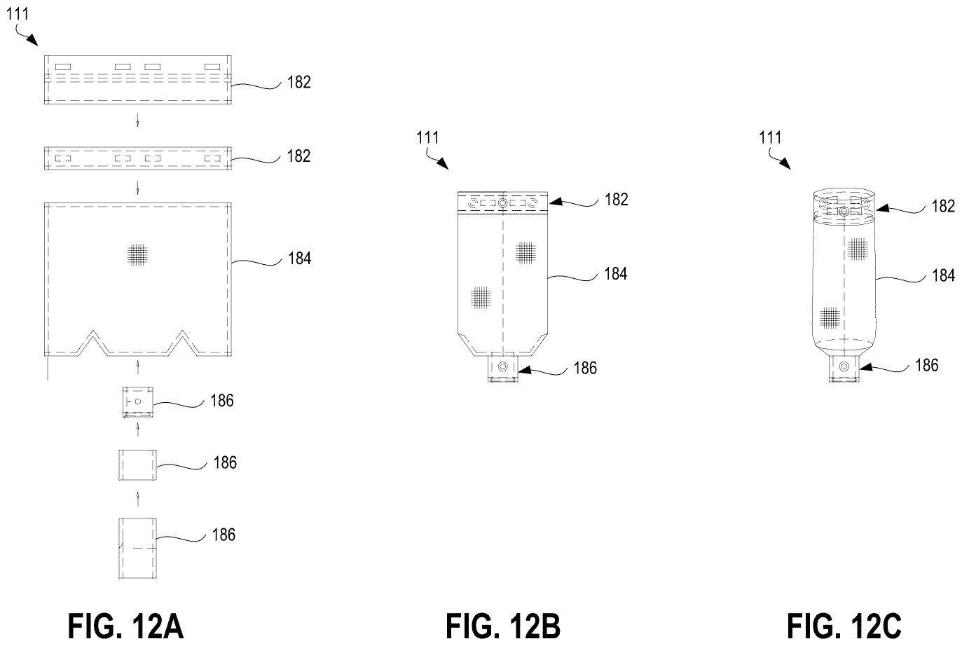

FIG. 12A is a schematic illustration of production steps of the small bag 111, in accordance with an embodiment.

The small bag 111 may be composed of a top portion 182, a central portion 184, and a bottom portion 186.

In FIG. 12A, production of the top portion 182 is shown as two step process, and production of the bottom portion is shown as a three-step process.

The top portion 182 comprises one or more pieces of textile or fabric. Such pieces of fabric may be composed of substantially non perforated or non fenestrated materials. For example, the top portion 182 may be a collar. In some embodiments, the top portion 182 may be composed of one or more pieces of fenestrated fabric. In some embodiments, the top portion 182 comprises one or more apertures or retaining elements suitable to couple with corresponding retaining elements on the receptacle 110. In various embodiments, the central portion 184 may be composed of fenestrated fabric to form a fenestrated body of the small bag 111. In various embodiments, the bottom portion 186 may form the tab 132. As indicated by the small arrows in FIG. 12A, the small bag 111 is put together by joining the top portion 182, the central portion 184, and the bottom portion 186. In various embodiments, such joining may be achieved by sewing or fusing. For example, in some embodiments the central portion 184 may be made of a plastic such as polypropylene.

In some embodiments, a fenestrated body of the small bag 111 may be at least partially formed by joining opposite longitudinal ends of the central portion 184.

FIG. 12B is a view of the small bag 111 in a collapsed state, in accordance with an embodiment.

FIG. 12C is a view of the small bag 111 in an expanded state, in accordance with an embodiment.

In the collapse state, the small bag 111 may assume a substantially cleaner or flat shape. In the expanded state, the small bag 111 may as human a tubular form. In some embodiments, the top portion 182 may comprise slots for receiving rods or other type of material to provide structure to the small bag 111.

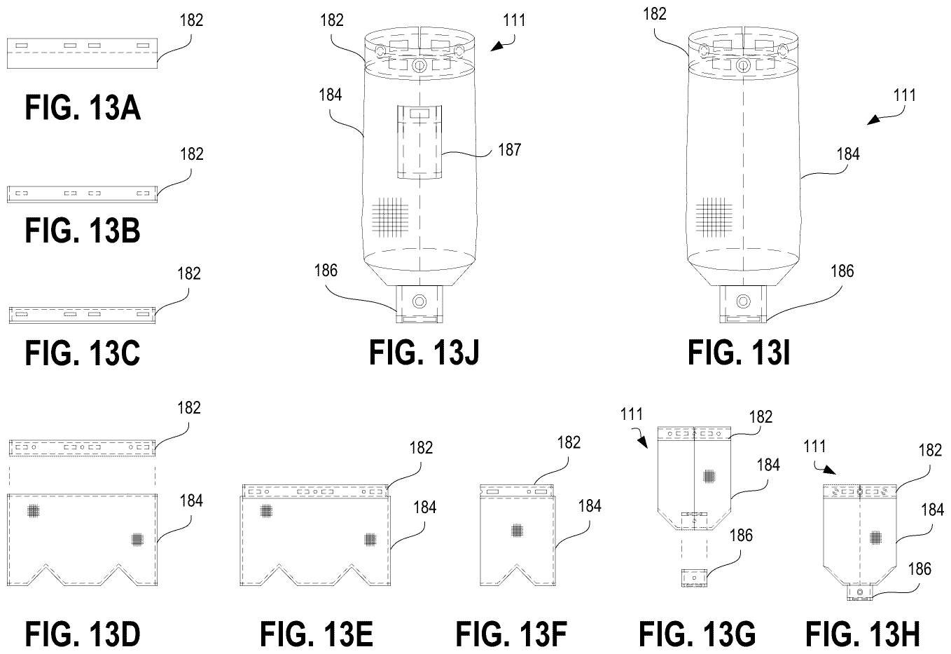

FIGS. 13A-13J illustrate various steps in assembling the small bag 111, in accordance with an embodiment.

FIG. 13A illustrates a first step of production of the small bag 111, in accordance with an embodiment.

In the first step of production, a collar of the top portion 182 is partially formed by affixing two parallel hook fastener strips at opposite ends of an upper half of a strip of fabric, and affixing two parallel loop fastener strips, arranged in sequence in-between the two parallel hook fastener strips, to the upper half of the strip of fabric.

FIG. 13B illustrates a second step of production of the small bag 111, in accordance with an embodiment.

In the second step of production, the collar is further partially formed. In particular, the strip of fabric is folded so that the upper half containing the affixed fastener strips (the hook fastener strips, and the loop fastener strips) faces outward, and then stitched around a lower lateral edge of the strip of fabric, e.g. by forming a lapped seam.

FIG. 13C illustrates a third step of production of the small bag 111, in accordance with an embodiment.

In the third step of production, an upper lateral edge of the folded strip of fabric is stitched to further form the collar.

FIG. 13D illustrates a fourth step of production of the small bag 111, in accordance with an embodiment.

In the fourth step of production, holes are punched in the collar in-between the fastener strips to complete the collar. The collar is then aligned with the central portion 184.

FIG. 13E illustrates a fifth step of production of the small bag 111, in accordance with an embodiment.

In the fifth step of production, the collar (the top portion 184) is stitched to an upper lateral edge of the central portion 184.

FIG. 13F illustrates a sixth step of production of the small bag 111, in accordance with an embodiment.

In the sixth step of production, the top portion 182 and the central portion 184 is folded and the two edges of the central portion 184 are stitched, while the collar remains unstitched (unjoined). The top portion 182 and the central portion 184 are folded such that the fastener strips face inwards.

FIG. 13G illustrates a seventh step of production of the small bag 111, in accordance with an embodiment.

In the seventh step of production, the bottom portion 186 is aligned with lower end of the central portion 184 and stitched thereto.

FIG. 13H is a front elevation view of the finished small bag 111, in accordance with an embodiment.

FIG. 13I is a perspective view of the finished small bag 111, in accordance with an embodiment.

FIG. 13J is a perspective view of the finished small bag 111 with an optional pocket 187 attached, in accordance with an embodiment.

In some embodiments, the optional pocket 187 may be stitched on to the central portion 184. In some embodiments, the optional pocket 187 may be fastened on to the central portion 184 via a hook and loop fastener.

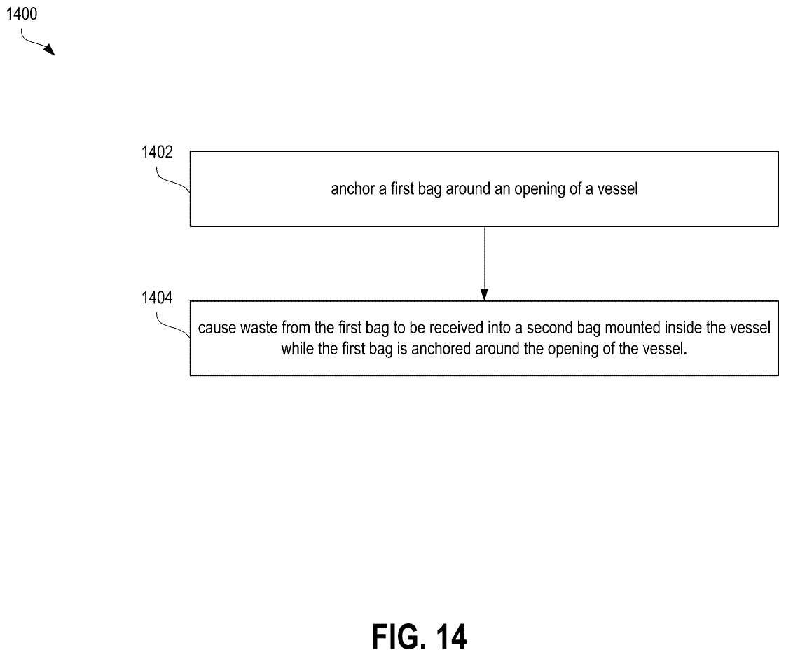

FIG. 14 is an example flow chart of a method 1400 of operating a waste collection system.

Step 1402 of the method 1400 includes anchoring a first bag around an opening of a vessel.

Step 1404 of the method 1400 includes causing waste from the first bag to be received into a second bag mounted inside the vessel while the first bag is anchored around the opening of the vessel.

In various embodiments, causing waste from the first bag to be received into a second bag mounted inside the vessel includes everting the first bag into the opening of the vessel to draw waste from the first bag into the second bag via the opening.

As can be understood, the examples described above and illustrated are intended to be exemplary only.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, reusable non-plastic bags may be used for the large bag, a non-fenestrated small bag may be used, and the waste collection system may be used to collect waste other than soft plastics. Yet further modifications could be implemented by a person of ordinary skill in the art in view of the present disclosure, which modifications would be within the scope of the present technology.

What is claimed is:

1. A kit for a waste collection system, comprising:
a receptacle, including
a vessel defining an opening that opens into an interior of the vessel and at least one drainage aperture separate from the opening to allow gas exchange between the interior and an exterior of the vessel,
a valve mounted on to the vessel to mitigate flow of waste from the interior to the exterior via the opening, and
a first plurality of retaining elements distributed around the opening exterior to the valve;
a first bag mounted in the interior of the vessel around the opening to receive waste via the valve, the first bag being perforated and expandable within the interior to expand as the waste is received into the vessel; and
a second bag defining a second plurality of retaining elements complementary to the first plurality of retaining elements to allow the second bag to be retained around the opening, exterior to the valve.

2. The kit of claim 1, wherein the valve is a restrictor check valve.

3. The kit of claim 1, wherein the vessel defines a lid that is openable to allow removal of the first bag from the vessel.

4. The kit of claim 3, wherein the opening is formed on the lid, and the lid is hinged to allow removal of the first bag from the first bag while the lid is attached to a body of the vessel.

5. The kit of claim 1, wherein the first bag is composed of polyethylene.

6. The kit of claim 1, wherein the first plurality of retaining elements and the second plurality of retaining elements comprise a plurality of apertures and a plurality of projections suitable to be complementarily received in the plurality of apertures.

7. The kit of claim 6, wherein the plurality of projections are cylinders, and the plurality of apertures are grommeted apertures formed around an open end of the second bag and suitable to receive the cylinders.

8. The kit of claim 1, wherein the receptacle further comprises a plate resiliently mounted in the interior of the vessel to urge the first bag against the opening to compact waste.

9. The kit of claim 8, wherein the plate is resiliently mounted in the interior via one or more resilient members extending from the plate to the vessel to urge the plate towards the opening.

10. The kit of claim 9, wherein the one or more resilient members are three resistance bands attached to the vessel around the opening and around an outer end of the plate to urge the plate towards the opening.

11. The kit of claim 1, wherein the second bag includes a fenestrated body to hold waste.

12. A waste collection system, comprising:
a receptacle, including
a vessel defining an opening that opens into an interior of the vessel and at least one drainage aperture separate from the opening to allow gas exchange between the interior and an exterior of the vessel,
a valve mounted on to the vessel to mitigate flow of waste from the interior to the exterior via the opening, and
a first plurality of retaining elements distributed around the opening exterior to the valve;
a first bag mounted in the interior of the vessel around the opening to receive waste via the valve, the first bag being perforated and expandable within the interior to expand as the waste is received into the vessel; and
a second bag, including
a fenestrated body to hold waste and defining an open end, and
a second plurality of retaining elements distributed around the open end and complementary to the first plurality of retaining elements to retain the second bag around the opening exterior to the valve.

13. The waste collection system of claim 12, wherein the valve is a restrictor check valve.

14. The waste collection system of claim 12, wherein the vessel defines a lid that is openable to allow removal of the first bag from the vessel.

15. The waste collection system of claim 14, wherein the opening is formed on the lid, and the lid is hinged to allow removal of the first bag from the first bag while the lid is attached to a body of the vessel.

16. The waste collection system of claim 12, wherein the first bag is composed of polyethylene.

17. The waste collection system of claim 12, wherein the first plurality of retaining elements and the second plurality of retaining elements comprise a plurality of apertures and a plurality of projections suitable to be complementarily received in the plurality of apertures.

18. The waste collection system of claim 17, wherein the plurality of projections are cylinders, and the plurality of apertures are grommeted apertures formed around an open end of the second bag and suitable to receive the cylinders.

19. The waste collection system of claim 12, wherein the receptacle further comprises a plate resiliently mounted in the interior of the vessel to urge the first bag against the opening to compact waste.

20. The waste collection system of claim 19, wherein the plate is resiliently mounted in the interior via one or more resilient members extending from the plate to the vessel to urge the plate towards the opening.

21. The waste collection system of claim 20, wherein the one or more resilient members are three resistance bands attached to the vessel around the opening and around an outer end of the plate to urge the plate towards the opening.

22. A waste receptacle, comprising:
a vessel defining an opening that opens into an interior of the vessel and at least one drainage aperture separate from the opening to allow gas exchange between the interior and an exterior of the vessel;
a valve mounted on to the vessel to mitigate flow of waste from the interior to the exterior via the opening; and
a first plurality of retaining elements distributed around the opening exterior to the valve and complementary to a second plurality of retaining elements on a second bag to allow the second bag to be retained around the opening, exterior to the valve, wherein a first bag is mounted in the interior of the vessel around the opening to receive waste via the valve, the first bag being perforated and expandable within the interior to expand as the waste is received into the vessel.

23. The waste receptacle of claim 22, wherein the valve is a restrictor check valve.

24. The waste receptacle of claim 22, wherein the vessel defines a lid that is openable to allow removal of the first bag from the vessel.

25. The waste receptacle of claim 24, wherein the opening is formed on the lid, and the lid is hinged to allow removal of the first bag from the first bag while the lid is attached to a body of the vessel.

26. The waste receptacle of claim 22, wherein the first bag is composed of polyethylene.

27. The waste receptacle of claim 22, wherein the first plurality of retaining elements and the second plurality of retaining elements comprise a plurality of apertures and a plurality of projections suitable to be complementarily received in the plurality of apertures.

28. The waste receptacle of claim 27, wherein the plurality of projections are cylinders.

29. The waste receptacle of claim 22, wherein the receptacle further comprises a plate resiliently mounted in the interior of the vessel to urge the first bag against the opening to compact waste.

30. The waste receptacle of claim 29, wherein the plate is resiliently mounted in the interior via one or more resilient members extending from the plate to the vessel to urge the plate towards the opening.

31. The waste receptacle of claim 30, wherein the one or more resilient members are three resistance bands attached to the vessel around the opening and around an outer end of the plate to urge the plate towards the opening.

32. A method of operating a waste collection system, comprising:
anchoring a first bag around an opening of a vessel; and
causing waste from the first bag to be received into a second bag mounted inside the vessel while the first bag is anchored around the opening of the vessel.

33. The method of claim 32, wherein causing waste from the first bag to be received into a second bag mounted inside the vessel includes
everting the first bag into the opening of the vessel to draw waste from the first bag into the second bag via the opening.
